(19) United States
(12) Patent Application Publication
(10) Pub. No.: US 2026/0328319 A1
(43) Pub. Date: Oct. 22, 2026

(54) FLUID CONDUIT WITH A FLUID CONDUCTING CORRUGATED TUBE

(71) Applicant: TI Automotive (Fuldabrueck) GmbH, Fuldabrueck (DE)

(72) Inventors: Iris BARTHEL, Schauenburg (DE); Reiner ROHDE, Malsfeld (DE); Thorsten THOMKE, Baunatal (DE); Joachim ORTH, Fritzlar (DE)

(21) Appl. No.: 19/107,686

(22) PCT Filed: Aug. 3, 2023
(86) PCT No.: PCT/EP2023/071539

§ 371 Date: Feb. 28, 2025

(30) Foreign Application Priority Data
Aug. 29, 2022 (EP) 22192682.7

(51) Int. Cl. F16L 25/00

(52) U.S. Cl. CPC F16L 25/0045; F16L 25/0054; F16L 2201/60

(57) ABSTRACT

A fluid conduit comprises a corrugated tube and at least conduit connector. The conduit connector has a connector body, the connector body comprising a plug section and the corrugated tube being plugged onto the plug section. The conduit connector comprises a fastening device, wherein the fastening device fastens the corrugated tube to the plug section. The plug section has a center axis, wherein the center axis defines an axial direction. The conduit connector comprises at least one sealing ring, the sealing ring comprising an elastomer. The plug section comprises at least one groove, the sealing ring being arranged in the groove.

### RELATED APPLICATIONS

The present disclosure claims priority to and is a national phase application of PCT Application PCT/EP 2023/071539, filed Aug. 3, 2023, which claims the benefit of and priority to European Application 22192682.7, filed on Aug. 29, 2022, the entire contents of each of which are incorporated herein by reference.

### FIELD

The disclosure relates to a fluid conduit comprising a corrugated tube and a conduit connector, wherein the conduit connector has a connector body, wherein the connector body includes a plug section, wherein the corrugated tube is plugged onto the plug section, wherein the conduit connector includes a fastening device, wherein the fastening device fastens the corrugated tube to the plug section, wherein the plug section has a center axis and the center axis defines an axial direction.

### BACKGROUND

A fluid conduit of this kind is known from WO 01/20216 A1 and is used to conduct wiping water at operating pressures of up to 3 bar. The fastening device comprises two arms that extend in the axial direction and are arranged diametrically opposite each other with respect to the center axis and the plug section. The arms each have three projections on their inner sides, which can engage in the grooves on the outer side of the corrugated tube. The arms are formed axially inward on the conduit connector or on a flange of the conduit connector and have axially outward, free ends that are not directly formed on the conduit connector. This allows the axially outward ends to be movable in a spring-like manner in the radial direction. This allows the arms to spread easily and resiliently when the corrugated tube is plugged onto the plug section of the conduit connector. The projections on the arms then engage in the grooves or corrugation troughs on the outside of the corrugated tube and press the corrugated tube onto the plug section. Finally, a locking ring is pushed onto the arms in an axially inward direction up to the stop on the flange of the conduit connector, which encloses the arms and thus secures the connection between the conduit connector and the corrugated tube. The locking ring has a projection on its inside, which engages in a corresponding groove on the outside of the arms and is thus fixed in turn. However, a disadvantage is the fact that in the known fluid conduit, at higher pressures, an adequate seal between the conduit connector and the corrugated tube is not achieved.

Due to a very similar design of a fluid conduit in DE 10 2005 007 217 B3, this fluid conduit also has the disadvantage of insufficient tightness at higher pressures. In the case of DE 197 23 410 A1, the fluid conduit is also in need of improvement at high pressures.

This disadvantage is overcome by means of an elastic sealing sleeve, as disclosed in DE 10 2011 005 220 A1. Like the corrugated tube, the sealing sleeve has a corrugated contour, whereby the diameter is smaller than that of the corrugated tube. This allows the sealing sleeve to be inserted into the corrugated tube. At its end facing the conduit connector, the sealing sleeve comprises a radially outwardly projecting flange. The elastic flange of the sealing sleeve serves as a stop at the front end of the corrugated tube and thus ensures a defined positioning of the sealing sleeve within the corrugated tube. The corrugated tube together with the inserted sealing sleeve is then plugged onto a plug section with a continuous, practically purely cylindrical surface.

### SUMMARY

We have discovered that despite the use of a sealing sleeve, leaks can occasionally occur. Consequently, when the connection is made, it must be carefully checked whether the fluid conduit is actually sealed in the area of the plug section.

The present disclosure provides a fluid conduit with a conduit connector and a fluid-conducting corrugated tube, whereby the production of the reliably fluid-tight connection between the conduit connector and the corrugated tube is to be designed to be even less laborious.

One embodiment of a fluid conduit includes a corrugated tube and at least one conduit connector, wherein the conduit connector has a connector body, wherein the connector body comprises a plug section, wherein the corrugated tube is plugged onto the plug section, wherein the conduit connector comprises a fastening device, wherein the fastening device fastens the corrugated tube to the plug section, wherein the plug section has a center axis and the center axis defines an axial direction, wherein the conduit connector comprises at least one sealing ring, wherein the sealing ring has an elastomer, wherein the plug section comprises at least one groove, wherein the sealing ring is arranged in the groove.

We have discovered that when the corrugated tube together with the elastic sealing sleeve from DE 10 2011 005 220 A1 is plugged onto the plug section, a frictional connection is created between the sealing sleeve and the plug section. This results in a high force to be applied in the axial direction. It was found that this is due in particular to the relatively large axial expansion of the sealing sleeve. This leads, firstly, to a laborious and cumbersome assembly and, secondly, to the fact that the sealing sleeve can slip a little way into the corrugated tube. The slippage is possibly due to the elastically designed flange of the sealing sleeve, so that the impact effect is limited. Then the sealing sleeve is no longer visible and the technician does not know whether the slippage of the sealing sleeve is critical for the fluid connection or not. We have also discovered that, in particular in cases where the sealing sleeve has slipped slightly but is still seated in a fluid-tight manner, the technician must check the fluid-tightness. In addition to the aforementioned axial force required to slide it on, this results in a not inconsiderable assembly effort.

We have found that a sealing ring requires significantly less axial force than the sealing sleeve. However, this is accompanied by a lower sealing effect, so that an expert would refrain from this measure. However, the present disclosure teaches that this disadvantage is overcome by providing a groove on the plug section for receiving a sealing ring. This is because the groove provides a sufficient form fit for the sealing ring, which reliably protects the sealing ring from slipping. It was unexpected and surprising to find that a sealing ring held by a groove on the plug section still provides a completely adequate and consistently reliable sealing effect, even though the corrugated tube has a strongly alternating surface on its inner side. We believe this is because the groove achieves a form fit that allows larger forces emanating from the corrugated tube and acting radially on the sealing ring. These larger radial forces achieve a greater sealing effect. At the same time, the connection between the corrugated tube and the conduit connector can be established with only a small amount of force and inspection, because the sealing ring can accept significantly smaller expansions in the axial direction due to the improved sealing effect, thus generating a correspondingly smaller force or friction fit. Consequently, a reliably fluid-tight fluid conduit is present, the corrugated tube of which can be manufactured and attached continuously without smooth sections and thus with little effort. As a result, the present disclosure provides a reliably tight fluid conduit that can be manufactured and attached with little effort despite the corrugated tube.

In comparison with the fluid conduit from DE 197 23 410 A1, it was found that the groove on the plug shaft provides sufficient fluid tightness. This is because the groove allows the sealing ring to make contact with the plug section at three points (on both groove walls and on the groove base), whereas the sealing ring from DE 197 23 410 A1 only makes contact with the cylindrical surface. In addition, the groove contributes to an improved tensile strength by the sealing ring engaging not only in the corrugated tube but also in the plug section. This also achieves a higher fluid seal in the event of larger axial tensile forces.

The term “corrugated tube” preferably refers to tubes with alternating inner and outer diameters, which may be sinusoidally corrugated, for example, but may also be rectangularly or sawtooth-corrugated. The term “corrugated tube” has evolved over time and, as a technical term, also regularly refers to a rectangular corrugation of the wall. Terms such as “corrugated” or terms with the root “wave” also preferably refer to corrugations in the broader sense and thus alternating inner and outer diameters and are not limited to sinusoidal corrugations of the wall.

The terms “corrugation trough” and “corrugation crest” are preferably related to the outside of the corrugated tube, so that the corrugation troughs are expediently the grooves on the outside of the corrugated tube, whereby the corrugation troughs are expediently separated from each other in the axial direction alternating with corrugation crests. The term “axial” preferably refers to a longitudinal or center axis of the plug section or of the respective section of the conduit connector or of the corrugated tube. It is preferred that the center axis defines an axial, a radial and a circumferential component.

It is possible that the connector body includes a connecting section for a connection to another fluid conducting component. Preferably, the connector body includes a fluid channel for fluidic connection of the plug section and the connecting section. The other fluid-conducting component may be, for example, another tube or an aggregate. The aggregate may be a tank, a pump, a valve, a nozzle or the like. The connecting section of the connector body is preferably located in the flow direction at an end of the connector body opposite to the plug section.

The connecting section can be a component of a form-fitting, force-fitting and/or material-fitting connection with the other fluid-conducting component. For example, the connecting section can be a component of a force-fitting press fit between the conduit connector or the connector body on the one hand and the other fluid-conducting component on the other. It is possible that the connecting section is connected to the other fluid-conducting component by welding. According to one embodiment, the connecting section of the conduit connector or connector body is integrally connected to the other fluid-conducting component. It is possible that the connecting section or the connector body is integrally molded to the other fluid-conducting component, for example by injection molding.

Preferably, the plug section includes a front end. It is advantageous if one end of the plug section tapers towards the front end, so that it is easier to plug the corrugated tube onto the plug section. The term “axially inward” preferably refers to an axial direction of the plug section that points from the front end of the plug section into the interior of the plug section or the connector body or the conduit connector. The term “axially inward” preferably also applies to the corrugated tube, so that the corrugated tube does not represent a separate reference frame for the directional orientations “inward” or “outward”. The term “axially” inward in relation to the corrugated tube therefore preferably means “towards the conduit connector”.

According to a preferred embodiment, the portion of the corrugated tube that is attached to the plug section is corrugated, at least in sections and preferably completely. It is preferred that the entire corrugated tube is corrugated at least along 50% or 70% or 90% or 99% of its axial extent. It is particularly preferred that the corrugated tube is corrugated along its entire axial extent. This has the advantage that the exact axial lengths of the corrugated and non-corrugated sections need not be taken into account when manufacturing the corrugated tube. This simplifies the manufacturing process, in particular the formation of the corrugation after extrusion or coextrusion, and also the cutting to length.

It is advantageous that the fastening device has entered or can enter into at least one form fit with the corrugated tube in the axial direction. Preferably, the fastening device engages on an outer side of the corrugated tube in at least one corrugation trough. Preferably, the fastening device comprises at least one retaining projection and, more preferably, at least two retaining projections. It is advantageous if the retaining projection or retaining projections engages/engage in at least one corrugation trough of the corrugated tube. It is expedient for the two retaining projections to be located diametrically opposite one another with respect to the center axis. It is possible that in the axial direction or in the longitudinal section of the fluid conduit, several retaining projections are arranged consecutively. Preferably, the retaining projection or retaining projections protrude in the radial direction.

It is preferred that the retaining projection or retaining projections have an insertion surface on its/their axially outward side, the insertion surface being rounded or beveled for easier insertion of the corrugation crests of the corrugated tube. It is possible that an axially inner side of the retaining projection or retaining projections is/are designed differently from the insertion surface. It is more difficult to pull out the corrugated tube and thus an axially outwardly acting pulling force acting on the corrugated tube to pull it out is greater than an axially inwardly acting compressive force on the corrugated tube to plug the corrugated tube onto the plug section. Preferably, the axially inner side of the retaining projection or retaining projections has/have a contour in a longitudinal section which extends more in the radial direction compared to the contour of the axially outer side of the retaining projection or retaining projections.

According to a preferred embodiment, the fastening device or the arms or a securing element exerts a clamping force on the corrugated tube or on the sealing ring in the radial direction. This initially achieves a particularly fluid-tight design of the fluid conduit. In addition, a large clamping force supports the mechanical fixing of the corrugated tube to the conduit connector. A clamping force acting in the radial direction particularly supports a form fit between the fastening device and the corrugated tube.

The fastening device preferably comprises at least two arms and more preferably at least three or four arms. The two arms are advantageously arranged diametrically or the four arms are arranged in pairs diametrically with respect to the center axis. It is advantageous if the longest extent of the arms extends in the axial direction or essentially in the axial direction. It is advantageous if an axially inward end of the arms is connected to the plug section and/or the connecting section and/or to a tube stop and/or to a flange of the conduit connector or connector body. Preferably, an axially outward end of the arms is free, so that the axially outward end of the arms is preferably movable in a resilient manner in the radial direction. It is preferred that the arms and the plug section define, in a longitudinal section, an intermediate space into which the corrugated tube can be inserted or has been inserted. It is highly desirable that the arms exert a clamping force on the corrugated tube and the sealing ring in the radial direction. It is particularly desirable that the arms each have the retaining projection or the retaining projections on their radially inner sides.

The fluid conduit or the fastening device or the corrugated tube advantageously includes at least one inner element, the at least one inner element preferably comprising an elastomer or being designed in a rubber-elastic manner, the inner element preferably being arranged in a radial direction between the fastening device or an arm and the corrugated tube. The at least one inner element may be arranged or attached on a radial inner side of an arm. It is possible that the at least one inner element has the retaining projection or the retaining projections. An inner element can be assigned to each of the arms. It is possible that the inner element is attached to the inner side of the arm by means of adhesive bonding.

Preferably, the inner element is arranged or attached on an outer side of the corrugated tube. It is highly preferred that the inner element is formed as a sleeve. Preferably, the inner element encloses the end of the corrugated tube that is attached to the plug section. It is highly preferred that the inner element be corrugated. It is particularly preferred that the inner element be mounted on the end of the corrugated tube by means of a force fit and/or form fit. It is advantageous that the inner element be formed as a corrugated sleeve and be mounted on the end of the corrugated tube by means of a force fit. Resilient inner elements produce a higher frictional connection or force-locked connection between the fastening device or the arms and the corrugated tube, thereby improving the fastening of the corrugated tube to the conduit connector. It is highly preferred that the arms are resilient and/or the inner element or inner elements are rubber-elastic.

It is advantageous that the conduit connector comprises a tube stop for stopping a front end of the corrugated tube in the axial direction. It is advantageous that the corrugated tube is cut to length in this way and/or the conduit connector is designed in this way and/or the tube stop is positioned and dimensioned in this way that the sealing ring-when the corrugated tube is plugged fully onto the plug section and when it comes into contact with the tube stop-rests against an inner side of a corrugation crest of the corrugated tube and is received by the inner side of the corrugation crest. It is advantageous that the corrugated tube is cut to length and/or the conduit connector is designed and/or the tube stop is positioned and/or dimensioned in such a way that the retaining projection or retaining projections of the fastening device and/or of one or more arms engages/engage in a corrugation trough and/or corrugation troughs of the corrugated tube. It is preferred that the retaining projection, when fully plugged on, is arranged axially outward of the sealing ring of the corrugated tube, so that the sealing ring preferably contributes to the fixing of the corrugated tube and engages behind the retaining projection. Advantageously, the corrugated tube is flexible so that minor deviations from the fully plugged-on state of the corrugated tube can be tolerated and the sealing ring still comes to rest on an inner side of a corrugated tube.

Preferably, the plug section comprises a cylindrical surface or outer side, at least in sections and more preferably along at least 20%, 30%, 40% or 50% of the length of the plug section. This ensures that no force emanating from the plug section acts on the corrugated tube in an axially outward direction.

It is advantageous if the connector body is of a single-piece and preferably—in particular injection molded—an integral design. It is advantageous if the conduit connector and/or the corrugated tube comprise a plastic. It is possible that the corrugated tube has a single-layer or multi-layer wall. It is expedient for the corrugated tube to be extruded or coextruded. It is preferred that the connecting body be manufactured separately from another pipe or from another fluidic component. It is expedient for the connecting section to include a front end, with the front end practically facing the other fluidic component.

According to a preferred embodiment, the conduit connector or the fastening device defines an open state for inserting the corrugated tube and a closed state for fixing the corrugated tube. The arms advantageously define the open state and the closed state. It is advantageous that the arms have a greater distance in the radial direction in relation to one another in the open state of the fastening device compared to the closed state. It is advantageous that less elastic restoring energy is stored in the arms in the open state compared to the closed state. Preferably, the conduit connector is designed such that the arms or the fastening device can be secured in the closed state, so that the restoring energy contained in the arms or the fastening device is stored by means of a/the securing element and can preferably be released by removing the securing element. Preferably, the reset energy stored in the arms or the fastening device can only be released when the securing element has been removed or moved.

The plug section may have an axial length from a front end to a/the tube stop, wherein the sealing ring or groove is/are arranged in one of the three middle fifths of the axial length of the plug section. Preferably, the sealing ring and/or the groove is/are located in the middle fifth of the axial length of the plug section. It is advantageous that a surface normal of a groove base of the groove extends in the radial direction. It is advantageous that the sealing ring has a rounded, preferably oval or circular, cross section along a longitudinal section of the plug section.

According to a preferred embodiment, the conduit connector or the fluid conduit comprises a securing element for securing the closed state of the fastening device. It is preferred that the securing element can be pushed onto the fastening device, preferably in the axial direction and more preferably in the axially outward direction. It is advantageous if the securing element is designed separately from the connector body and the fastening device. It is advantageous if the securing element comprises a plastic. It is preferred if the securing element is ring-like. It is preferred if the securing element runs around the fastening device and/or the connector body and/or one end of the corrugated tube in the direction of rotation, at least partially and preferably completely.

It is preferred that the conduit connector and the fluid conduit, respectively, are designed such that the securing element is movable relative to the connector body from an open position to a closed position and vice versa. It is preferred that the transition from the open position to the closed position is achievable by a displacement of the securing element, preferably in the axial direction and particularly preferably in the axially outward direction. It is preferred that the securing element secures or defines a closed state of the fastening device. Securing of the closed state of the fastening device by the securing element can be realized in a force-locking and/or form-fitting manner. It is advantageous if the securing element is latched to the connector body or the fastening device in the open position and/or in the closed position. It is advantageous for the securing element to be in the closed position while the fastening device is simultaneously in the closed state. It is advantageous for the securing element to be in an open position while the fastening device is in an open state. It is advantageous that the connector body and the fastening device, respectively, comprise a guide for guiding the securing element from the open position to the closed position and preferably also vice versa, wherein the guide preferably only allows the securing element to move in the axial direction.

It is preferred that the securing element, when moving from the open position to the closed position, pushes the arms radially inwards, causing the fastening device to move into the closed state. It is preferred that the conduit connector or the securing element or the connector body or the fastening device is/are designed so that the securing element, when moving from the open position to the closed position, moves the arms of the fastening device-preferably by a displacement in the axial direction and particularly preferably in the axial outward direction-in the radial direction towards one another, so that preferably a clamping force acts in the radial direction on the corrugated tube and an additional clamping force acts on the sealing ring.

The advantage of the securing element is, on the one hand, that it secures the closed state of the fastening device. Another advantage is that the securing element can exert a large radial clamping effect on the fastening device, the corrugated tube and the sealing ring. The securing element also provides an indicator function and allows for a very simple visual distinction between the closed and open state of the fastening device.

According to an embodiment, at least one part of the fastening device has been manufactured or injection molded separately from the connector body. It is advantageous if the fastening device, or the entire fastening device, or the at least one part of the fastening device that is manufactured separately from the connector body, is connected to the connector body in a force-fitting, form-fitting or material-locking manner. It is advantageous if the at least one part of the fastening device that is manufactured separately from the connector body is not connected integrally to the connector body. The at least one part of the fastening device, which is produced separately from the connector body, preferably includes the arms and, more preferably, an arm sleeve. The arm sleeve is preferably at least partially circumferential and more preferably completely circumferential. It is preferred that the arms are connected to the arm sleeve and are preferably integrally connected to the arm sleeve. The at least one part of the fastening device comprising the arms and the arm sleeve is preferably manufactured separately from the connector body by means of injection molding. It is possible that the at least one part of the fastening device manufactured separately from the connector body has been subsequently connected to the connector body by means of welding to form a single piece (but not integrally). The arm sleeve may comprise an arm sleeve fastening. The arm sleeve fastening can be designed as a latching element for latching with the connector body or tube stop. It is possible for the arm sleeve to be fastened to the connector body or the tube stop or the plug section or the connecting section in a force-fitting, form-fitting or material-locking manner, preferably with the aid of the arm sleeve fastening. It is advantageous if the connector body or tube stop includes a latching means for connection to the arm sleeve fastening. The separate production of at least one part of the fastening device and in particular of the arms separately from the connector body allows a sometimes more favorable production of the conduit connector due to simpler injection molding geometries.

According to one embodiment, the conduit connector comprises a closing element, wherein the closing element is rotatable about the center axis at least in sections, wherein the closing element is configured such that it can be brought into engagement by said rotation with at least one corrugation trough of the corrugated tube by the rotation. Preferably, the closing element comprises at least two closing arms. It is advantageous if at least one closing arm comprises a retaining projection for engaging in a corrugation trough of the corrugated tube. It is advantageous if the closing element has a closing sleeve. It is advantageous if the closing arms are connected to the closing sleeve. It is advantageous if the closing element is formed in one piece and in particular integrally, preferably by injection molding. It is preferred that the closing element is compressible in the radial direction. It is preferred that the closing arms approach each other in the radial direction due to the rotational movement of the closing element. It is useful if the closing element sleeve is rotatably mounted on the connector body. It is advantageous if the closing element or the closing arms are continuously compressed in the radial direction and moved towards each other due to the rotation about the center axis and due to contact with a radial inner side of the arms of the fastening device. The closing element preferably defines an opening position and/or a closing position. The opening position can be defined by a stop or latching means of the closing element on the connector body and/or on the fastening device. The closing position of the closing element can be defined by a stop or latching means on the connector body or on the fastening device. It is possible that the closing position of the closing element is defined by a frictional connection between the closing arms and the arms of the fastening device.

According to one embodiment, the fastening device is designed so that the corrugated tube latches with the fastening device when it is plugged onto the plug section. This results in a very fast connection. It is advantageous that the arms of the fastening device are designed in a relaxed state in such a way that the retaining projection or the retaining projections of the respective arm engage in the corrugation trough or corrugation troughs of the corrugated tube. Preferably, the corrugated tube and the arms are designed such that the corrugation crests push the arms radially outwards, so that an elastic restoring energy is stored in the arms until the retaining projection or the retaining projections can (re)engage in a corrugation trough. It is preferred that the arms or retaining projections, when engaging in a corrugation trough or corrugation troughs, exert a radially inward clamping force on the corrugation trough or corrugation troughs. It is preferred that the conduit connector or the connector body or the fastening device or the arms or the corrugated tube is/are designed such that the corrugated tube experiences several locking processes in succession during the sliding-on.

According to a preferred embodiment, the conduit connector has an indicating device, in particular an indicating element and/or an indicating marker, for indicating a/the closed state of the fastening device. The indicating element can be designed to be movable or immovable. It is advantageous that the securing element or the closing element is the indicating element, so that the closed state of the fastening device or fluid conduit is indicated by the position of the securing element or closing element. It is preferred that the indicating element is movable in the axial and/or radial direction.

More particularly, the indicator marker comprises a visually or electromagnetically readable device. It is possible that the electromagnetically readable device is readable by radio. The fluid conduit may include a sensor for detecting the closed state of the fastening device. The sensor may be associated with a communication unit, such as an RFID chip, so that, preferably, an external reader can read the state of the fastening device. The visually readable means may be, for example, a symbol, a bar code, or a QR code. According to a preferred embodiment, the visually readable means appears due to the transfer of the securing element or the closing element from the open position to the closed position. It is particularly preferred that the indicator marker or the visually readable device is hidden by the securing element or the closing element in the open position or in the closed position and is optically readable by a reading device in the closed position or the open position of the securing element or the closing element.

The above-mentioned problem is solved by using the fluid conduit in a vehicle, preferably in a land vehicle, more preferably in a road vehicle. It is preferred that the vehicle is an electric vehicle and has a battery for driving an electric motor. Preferably, the fluid conduit is part of a coolant circuit for cooling the battery.

### BRIEF DESCRIPTION OF THE DRAWINGS

The disclosure will be described below with reference to a number of examples with a number of schematic figures.

FIG. 1 shows a longitudinal section through a first fluid conduit according to the disclosure,

FIG. 2 a longitudinal section through a second fluid conduit according to the disclosure with a fastening device in an open state,

FIG. 3 the fluid conduit from FIG. 2 with the fastening device in a closed state,

FIG. 4 a third fluid conduit according to the disclosure in a longitudinal section,

FIG. 5 a fourth fluid conduit according to the disclosure in a longitudinal section,

FIG. 6A a cross-section of the fluid conduit from FIG. 5 with a fastening device in an open state, and

FIG. 6B the fluid conduit from FIG. 5 in cross-section with a fastening device in the closed state.

### DETAILED DESCRIPTION

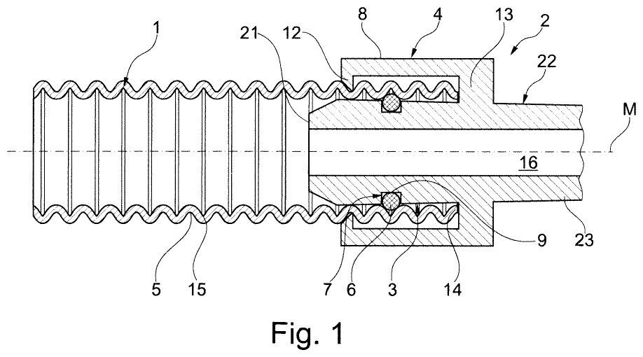

FIG. 1 shows a first embodiment of the disclosure in the form of a fluid conduit 1, 2 comprising a corrugated tube 1 and a conduit connector 2. The corrugated tube 1 may comprise one or more plastics and in particular be designed as a multilayer tube. The conduit connector 2 comprises a connector body 22, the connector body 22 preferably being formed in one piece and, more preferably, integrally. The connector body 22 comprises a plug section 3, which is inserted into the corrugated tube 1. The plug section 3 has a center axis M, which defines an axial, a radial and a circumferential direction.

The connector body 22 preferably includes a connecting section 23. In a practical arrangement, the fluid channel 16 connects the plug section 3 fluidically to the connecting section 23. The connecting section 23 may be connected in a force-fitting, form-fitting or materially integral manner to other fluid-conducting components not shown here. The other fluid-conducting components may be other tubes or units. Examples of units are pumps, nozzles, tanks and the like. However, the connecting section 23 may also be integrally connected to the other fluid-conducting component. It is possible that the connector body 2 is formed, for example by injection molding, onto the other fluid-conducting component. The fluid channel 16 fluidically connects the corrugated tube 1 to the other fluid-conducting component.

The corrugated tube 1 of the example according to FIG. 1 is sinusoidally corrugated. In other examples not shown here, the corrugated tubes may be configured to be rectangularly corrugated. On the outside of the corrugated tube 1, corrugation troughs 5 usefully alternate with corrugation crests 15. It is preferred that the corrugated tube 1 is corrugated in the axial overlap region with the plug section 3 at least in sections and preferably throughout. It is particularly preferred that the entire corrugated tube 1 is corrugated throughout.

With regard to FIG. 1, it can also be seen that the conduit connector 2 comprises a sealing ring 6. The sealing ring 6 preferably comprises an elastic material and, even more preferably, consists only of the elastic material. The sealing ring 6 is arranged in a groove 7, the groove 7 being arranged in the region of the plug section 3 and preferably on an outer side of the plug section 3. The groove 7 advantageously comprises a groove base 9.

The conduit connector 2 according to FIG. 1 comprises a fastening device 4, the fastening device 4 fastening the corrugated tube 1 to the plug section 3. Advantageously, the fastening device 4 comprises at least two arms 8 which are preferably located diametrically opposite one another with respect to the center axis M. It is preferred that the fastening device 4 or arms 8, respectively, each comprise at least one radially inwardly projecting retaining projection 12. It is preferred that the retaining projections 12 are arranged at axial free ends of the arms 8. Preferably, the retaining projections 12 have tapered insertion surfaces on their axially outer side to facilitate insertion of the corrugated tube 1.

Preferably, the arms 8 are formed in a resiliently elastic manner in the radial direction at their free ends, so that the corrugation crests 15 elastically prestress the arms 8 in a radially outward direction when the corrugated tube 1 is plugged onto the plug section 3. Thereupon, the arms 8 or retaining projections 12 release their stored restoring energy when they reach the next corrugation trough 5 and engage in the corresponding corrugation trough 5. Preferably, the retaining projections 12 are not tapered or rounded on their axially inner side, so that pulling out the corrugated tube 1 is correspondingly more difficult or ideally prevented.

It is highly desirable for the fastening device 4 to have a tube stop 13, see FIG. 1. The conduit connector 2 is preferably designed so that the corrugated tube 1, when fully plugged onto the plug section 3, abuts against the tube stop 13 with a front end 14. It is advantageous that the tube stop 13 defines an axial length of the overlap between the corrugated tube 1 and the plug section 3. It is particularly preferred that the corrugated tube 1 and/or the conduit connector 2 are configured such that the sealing ring 6 rests against an inner-side indentation of a corrugation crest 15 in a state in which the corrugated tube 1 is plugged completely onto the plug section 3. It is highly desirable that the corrugated tube 1 and the conduit connector 2 are designed such that, when the corrugated tube 1 is plugged fully onto the plug section 3, the retaining projections 12 engage in a corrugation trough 5 of the corrugated tube 1.

In the embodiment according to FIG. 1, the tube stop 13 is connected in one piece and preferably integrally to the arms 8 or the retaining projections 12. The tube stop 13 or the arms 8 are advantageously connected in one piece or integrally to the plug section 3 and/or the connecting section 23 and/or the connector body 22.

In particular, the arms 8 or the retaining projections 12 according to FIG. 1 exert a force acting radially inwards on the corrugation trough 5 in the state of the corrugated tube 1 in which it is preferably plugged completely onto the plug section 3. This increases the frictional connection with the sealing ring 6. The embodiment according to FIG. 1 is particularly suitable for producing a fluid-tight connection between the conduit connector 2 and the corrugated tube 1 by means of a single plug-on movement. The embodiment according to FIG. 1 is more suitable for fluid conduits 1, 2 or fluid applications with lower pressures.

In an embodiment not shown here, the retaining projections 12 engage in a corrugation trough 5, which is adjacent to the corrugation crest 15 of the sealing ring 6 when the corrugated tube 1 is fully inserted. The retaining projections 12 are particularly preferably located in the corrugation trough 5 which directly follows the corrugation crest 15 with the sealing ring 6 in the axially outward direction.

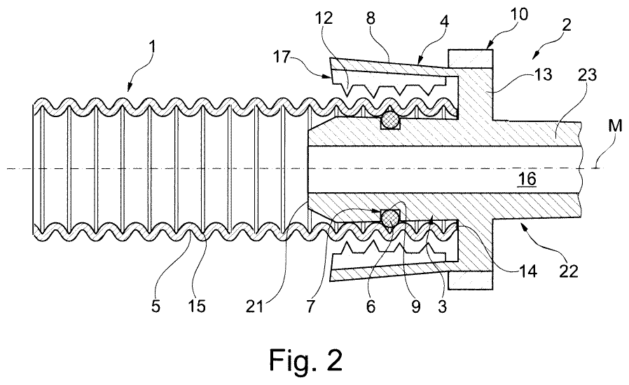

The second embodiment according to FIG. 2 is identical in terms of the corrugated tube 1. The conduit connector 2 is also identical to the first embodiment in terms of the fluid channel 16, the connecting section 23, the plug section 3, the sealing ring 6 and the groove 7. The differences between the first embodiment according to FIG. 1 and the second embodiment according to FIG. 2 are mainly to be found in the fastening device 4.

The fastening device 4 according to FIG. 2 preferably comprises at least two arms 8, which preferably extend with their longitudinal extent in the axial direction. The conduit connector 2 advantageously includes a tube stop 13. The tube stop 13 is preferably integrally connected to the connecting section 23 and the plug section 3, respectively. In the present embodiment according to FIG. 2, the tube stop 13 is one piece with and preferably integrally connected to the arms 8. The fastening device 4 and the arms 8 can have a retaining projection 12 or several retaining projections 12, so that the retaining projections 12 of the fastening device 4 can engage in several corrugation troughs 5.

It is advantageous that the fastening device 4 according to FIG. 2 comprises at least one inner element 17. The at least one inner element is preferably arranged on the inside of each arm 8 and preferably comprises the retaining projection 12 or retaining projections 12. It is advantageous that the inner element 17 or inner elements 17 comprise an elastomer or are made of an elastomer. It is possible that the inner element 17 is glued to an inner side of the associated arm 8. The arms 8 are preferably designed such that their free ends have a greater radial distance from one another in a relaxed state than in a tensioned state. It is highly preferred that the relaxed state of the arms 8 corresponds to an open state of the fastening device 4. It is expedient that a tensioned state of the arms 8 corresponds to a closed state of the fastening device 4.

Preferably, the conduit connector 2 according to FIG. 2 comprises a securing element 10 for securing a closed state of the fastening device. The securing element 10 is preferably annular. It is preferred that the securing element 10 is arranged to be displaceable in the axial direction relative to the fastening device 4 and the connector body 22, respectively. Preferably, in an open state of the fastening device 4, the securing element 10 is in an opening position, as shown in FIG. 2.

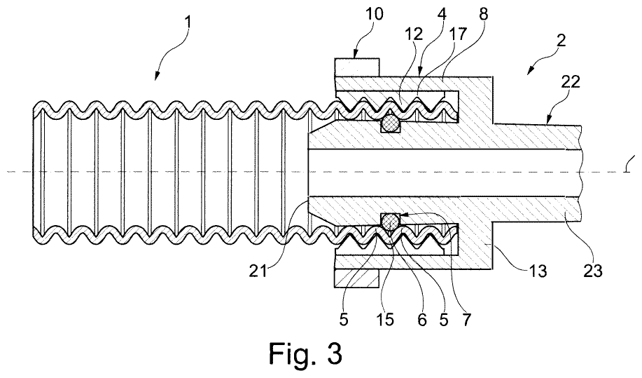

FIG. 3 illustrates the second embodiment from FIG. 2, wherein the fluid conduit 1, 2 and the fastening device 4 are in a closed state and the securing element 10 is in a closed position. It is highly preferred that the securing element 10 in/at the closed position is further axially outwardly disposed as compared to the open position. The locking position and/or the opening position are advantageously defined by detent elements, not shown here, on the connector body 22 or on the fastening device 4 and the securing element 10. It is highly desirable that the securing element 10 and the fastening device 4 are designed such that the arms 8 are moved towards each other in the radial direction due to the closed position of the securing element 10. It is useful for the retaining projections 12 to engage in the corrugation troughs 5 in the closed state of the fastening device 4 and to produce a form fit.

In particular, the securing element 10 in the closed position and the fastening device 4 in the closed state are designed such that the arms 8 exert a radially inward force on the corrugated tube 1 and the sealing ring 6. It is advantageous that a force closure between an outer side of the corrugated tube 1 and the inner elements 17 or arms 8 is generated due to the force exerted by the securing element 10 on the arms 8. It is preferred that the locking position of the securing element 10 increases the frictional connection between the sealing ring 6 and the corrugated tube 1 in comparison to the open state of the fastening device 4 or the fluid conduit 1, 2. Due to the securing element 10 and/or the inner elements 17, the embodiment according to FIGS. 2 and 3 is suitable for higher fluid pressures.

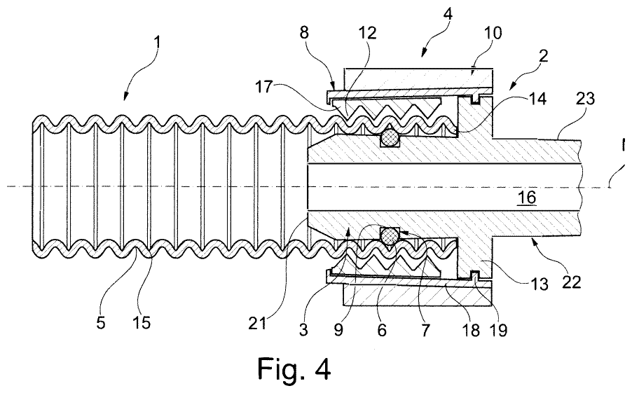

FIG. 4 shows a third embodiment in a closed state of the fastening device 4. The corrugated tube 1 of the third embodiment is identical to the corrugated tubes 1 of the first two embodiments. Again, the differences to the other embodiments can be seen in the fastening device 4. Preferably, the conduit connector 2 or the connector body 22 comprises a tube stop 13. The tube stop 13 of this embodiment is advantageously connected in one piece or integrally to the connecting section 23 or the plug section 3.

However, in the case of the third embodiment, the tube stop 13 is not integrally connected to the arms 8. Preferably, the at least two and preferably at least four arms 8 are connected to one another by an arm sleeve 18. It is advantageous for the arms 8 and the arm sleeve 18 to be in one piece and preferably integrally connected to one another. It is preferred that the arm sleeve 18 comprises an arm sleeve fastening 19. The arm sleeve fastening 19 can be formed as a latching element which interacts with the tube stop 13 and preferably engages in the tube stop 13.

The fastening device 4 of the third embodiment preferably includes inner elements 17, as already described in the case of the second embodiment. The arms 8 of the fastening device 4 of the third embodiment are preferably designed such that in an open state they are at a greater radial distance from one another compared to a closed state as shown in FIG. 4.

The securing element 10 of the third embodiment is axially more extended compared to the securing element 10 of the second embodiment. It is useful to define the closed position shown in FIG. 4 and/or the open position of the securing element 10, which is not shown here, by means of latching elements between the arms 8 or the arm sleeve 18 and the securing element 10. It is preferred that the securing element 10 is arranged axially further inward in the opening position compared to the closing position. It is particularly advantageous that the securing element 10 exerts a greater force acting radially inwards on the arms 8, the inner elements 17, the corrugated tube 1 and the sealing ring 6 in the locking position compared to the opening position. The essential difference between the third and second embodiment thus consists in the separately manufactured arms 8. This allows for simpler injection molding tools for the conduit connector 2. Furthermore, the inner elements 17 can be better attached to the insides of the arms 8.

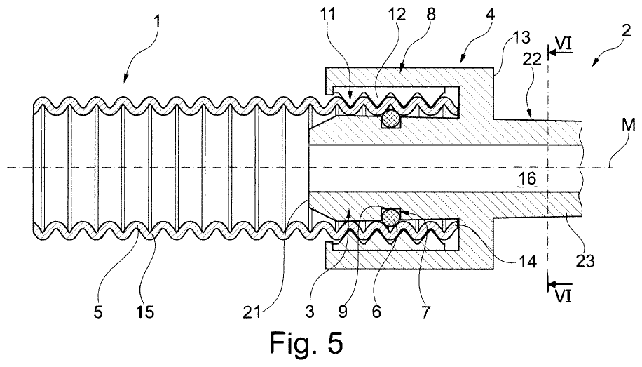

FIG. 5 shows a fourth embodiment of a fluid conduit 1, 2 according to the disclosure. The fluid conduit 1, 2 comprises a corrugated tube 1 and a conduit connector 2. The corrugated tube 1 is identical to the corrugated tubes 1 of the other embodiments. The conduit connector 2 comprises a fastening device 4 and a fluid channel 16. The fluid channel 16 is formed by a plug section 3 and preferably by a connecting section 23. The plug section 3, the connecting section 23, the sealing ring 6 and the groove 7 are designed identically to the other embodiments.

The conduit connector 2 comprises a tube stop 13, the tube stop preferably being connected in one piece and more preferably integrally to the plug section 3 or the connecting section 23. The fastening device 4 advantageously comprises two arms 8. The arms 8 of the fourth embodiment are advantageously arranged diametrically opposite one another with respect to the center axis M. The arms 8 are advantageously connected in one piece and more advantageously integrally to the tube stop 13.

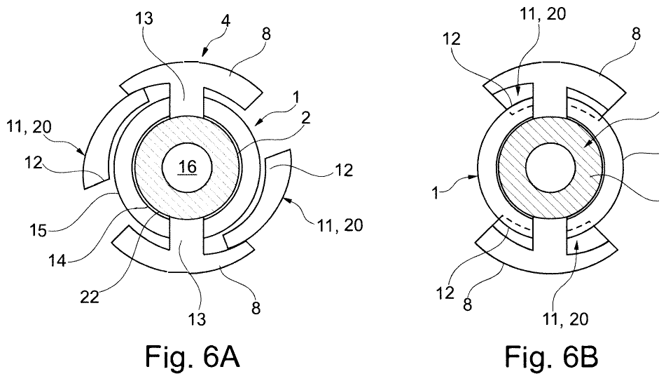

The conduit connector 2 preferably includes a closing element 11 that is arranged on the inside of the arms 8. The closing element 11 is preferably designed so that it can be rotated in the circumferential direction relative to the arms 8, as can be seen from the cross sections in FIGS. 6A and 6B. FIG. 6A shows an open position of the closing element 11, while FIG. 6B shows a closed position of the closing element 11. The closing element 11 preferably includes two closing arms 20, which are located diametrically opposite one another with respect to the center axis M. The closing arms 20 are connected to one another in the peripheral direction via a closing element sleeve not shown here. It is advantageous for the closing element sleeve to be located further in axially in relation to the closing arms 20.

The closing arms 20 are preferably designed to be resilient in the radial direction. The arms 8 are preferably designed to be rigid. It is highly desirable that the closing element 11 be compressed in the radial direction by the arms 8 due to the rotational movement, or that the closing arms 20 be moved radially towards one another, so that the closing arms 20 engage with at least one corrugation trough 5 or two corrugation crests 15. As a result, the closing arms 20 or their retaining projections 12 mesh with the corrugation crests, as can be seen in FIGS. 5 and 6B.

Preferably, an overlap in the circumferential direction between a closing arm 20 and an arm 8 is less in the open position than in the closed position. It is preferred that the closing arms 20 taper in the circumferential direction (clockwise or counterclockwise) in a cross section. Preferably, the arms 8 taper in the circumferential direction in the cross section (counterclockwise or clockwise, respectively). It is highly desirable that the closing element 11, in the locking position, exerts a force on the corrugated tube 1 and the sealing ring 6 that acts radially inwards. Preferably, in the case of the opening position (FIG. 6A) of the closing element, there is neither a frictional connection nor a form-fitting connection with the corrugated tube 1.

In embodiments not shown here, the securing element 10 and/or the closing element 11 can be indicating elements 10, 11 for indicating an open or closed position. It is possible that the indicating element 10, 11 covers an indicating marker, not shown here, in the form of, for example, a QR code on the connector body 22 in the open position. In the respective closed position, the indicating element 10, 11 releases the display marker so that a scanner can read the state of the indicating element 10, 11 on the basis of the display marker.

### LIST OF REFERENCE SIGNS

1 Corrugated tube
2 Conduit connector
1, 2 Fluid conduit
3 Plug section
4 Fastening device
5 Corrugation trough
6 Sealing projection
7 Groove
8 Arm
9 Groove base
10 Securing element
11 Closing element
10, 11 Indicating element
12 Retaining projection
13 Tube stop
14 Front end
15 Corrugation crest
16 Fluid channel
17 Inner element
18 Arm sleeve
19 Arm sleeve fastening
20 Closing arm
21 Front end
22 Connector body
23 Connecting section
M Center axis

1. A fluid conduit comprising:
a corrugated tube; and
at least one conduit connector, the conduit connector comprising a connector body, the connector body having a plug section, the corrugated tube being plugged onto the plug section,
wherein the conduit connector comprises a fastening device, the fastening device fastening the corrugated tube to the plug section or connector body, the plug section having a center axis and the center axis defining an axial direction;
wherein the conduit connector comprises at least one sealing ring, the sealing ring comprising an elastomer, the plug section comprising at least one groove, the sealing ring being arranged in the groove.

2. The fluid conduit according to claim 1, wherein the portion of the corrugated tube that is plugged onto the plug section is corrugated at least in sections.

3. The fluid conduit according to claim 1, wherein the fastening device has a form-fit connection with the corrugated tube in the axial direction.

4. The fluid conduit according to claim 1, wherein the fastening device or the conduit connector exerts a clamping force on the corrugated tube or the sealing ring in the radial direction.

5. The fluid conduit according to claim 1, wherein the fastening device comprises at least two arms which are arranged diametrically with respect to one another about the center axis, wherein the arms extend in the axial direction.

6. The fluid conduit according to claim 1, wherein the fluid conduit or the fastening device or the corrugated tube has at least one inner element, the inner element comprising an elastomer or being designed in an rubber-elastic manner, the inner element being arranged in the radial direction between the fastening device or an arm and the corrugated tube.

7. The fluid conduit according to claim 1, the conduit connector comprising a tube stop for stopping a front end of the corrugated tube in the axial direction.

8. The fluid conduit according to claim 1, wherein the plug section has at least in sections a cylindrical surface or outer side.

9. The fluid conduit according to claim 1, wherein the conduit connector or the fastening device defines an open state for introducing the corrugated tube and a closed state for fixing the corrugated tube.

10. The fluid conduit according to claim 1, wherein the conduit connector comprises a securing element for securing a closed state of the fastening device, wherein the securing element for securing the closed state of the fastening device can be pushed onto the fastening device, in the axial direction.

11. The fluid conduit according to claim 1, wherein at least one part of the fastening device is manufactured separately from the connector body, wherein the separately manufactured part of the fastening device is connected to the connector body.

12. The fluid conduit according to claim 1, wherein the conduit connector comprises a closing element, wherein the closing element is rotatable about the center axis at least in sections, wherein the closing element is configured such that it can be brought into engagement by said rotation with at least one corrugation trough of the corrugated tube.

13. The fluid conduit according to claim 1, wherein the fastening device is configured such that the corrugated tube latches with the fastening device when it is pushed onto the plug section.

14. The fluid conduit according to claim 1, wherein the conduit connector has an indicating element and/or an indicating marker, for indicating a closed state of the fastening device.

15. Use of the fluid conduit constructed according to claim 1 in a vehicle, preferably in a land vehicle, wherein the vehicle has a battery for driving an electric motor, and wherein the fluid conduit is part of a coolant circuit for cooling the battery.
